(19) United States
(12) Patent Application Publication
(10) Pub. No.: US 2015/0363658 A1
(43) Pub. Date: Dec. 17, 2015

(54) VISUALIZATION OF A COMPUTER-GENERATED IMAGE OF A DOCUMENT

(71) Applicant: ABBYY Development LLC, Moscow (RU)

(72) Inventor: Sergey Anatolyevich Kuznetsov, Moscow Region (RU)

(21) Appl. No.: 14/508,617

(22) Filed: Oct. 7, 2014

(30) Foreign Application Priority Data
Jun. 17, 2014 (RU) 2014124525

(51) Int. Cl. G06K 9/18; G06T 7/40

(52) U.S. Cl. CPC G06K 9/18; G06T 7/408

(57) ABSTRACT

Techniques for visualizing a computer-generated image of a document are provided. The image is produced using an OCR/ICR-enabled device. In the image, linear identifiers are used to designate properties and states of machine interpretation of contents of structural blocks of the document.

### CROSS REFERENCE TO RELATED APPLICATIONS

This application claims the benefit of priority to Russian Patent Application No. 2014124525, filed Jun. 17, 2014; the disclosure of which is incorporated herein by reference.

### FIELD OF THE INVENTION

The present disclosure relates to the field of optical character recognition (OCR) and intelligent character recognition (ICR).

### BACKGROUND OF THE INVENTION

OCR/ICR techniques are generally used for transforming images of paper documents in computer readable and editable formats, as well as for extracting data from the documents. In operation, OCR/ICR-enabled devices perform computerized scanning of the documents and machine analysis of obtained scans (i.e., scan files of the documents).

Displaying the results of the machine analysis, the OCR/ICR-enabled devices traditionally identify recognized and un-recognized portions of the documents using various highlighting schemes. However, differences in color reproduction of computer displays and printers, as well as variations in users' color perceptions may limit an amount of outputted color-coded information or cause interpretational errors.

### SUMMARY OF THE INVENTION

Techniques for visualizing a computer-generated image of a document are provided. The image is generally produced using OCR/ICR-enabled devices. In the image, structural blocks of the document are identified and supplemented with linear identifiers, which designate properties and states of machine interpretation of contents of the structural blocks.

In applications, such identifiers (single or multiple solid, dashed, dotted or dash-dotted lines having sections of same or different widths, lines formed using pre-selected characters, and the like) are used for selectively separating, underlining or hatching at least portions of the structural blocks.

In further embodiments, users of the image of the document are provided with graphical user interface (GUI) tools adapted for applying to the computer-generated image additional identifiers or modifying/replacing the existing identifiers. Thereafter, such user-performed editorial changes may be incorporated in the image of the document.

Various other aspects and embodiments of the disclosure are described in further detail below. It has been contemplated that features of one embodiment of the disclosure may be incorporated in other embodiments thereof without further recitation.

The Summary is neither intended nor should be construed as being representative of the full extent and scope of the present disclosure. All objects, features and advantages of the present disclosure will become apparent in the following detailed written description and in conjunction with the accompanying drawings.

The novel features believed being characteristic of the description are set forth in the appended claims.

### BRIEF DESCRIPTION OF THE DRAWINGS

FIG. 1 depicts a diagram illustrating a method of visualizing a computer-generated image of a document according to one embodiment of the present disclosure.

FIG. 2 depicts an exemplary computer-generated image illustrating the method of FIG. 1 according to one embodiment of the present disclosure.

FIG. 3 depicts an exemplary computer platform utilizing the method of FIG. 1 according to one embodiment of the present disclosure.

The images in the drawings are simplified for illustrative purposes and are not depicted to scale.

To facilitate understanding, identical reference numerals are used in the drawings to designate, where possible, substantially identical elements that are common to the figures, except that alphanumerical extensions and/or suffixes may be added, when appropriate, to differentiate such elements.

### DETAILED DESCRIPTION OF THE INVENTION

Objects, features and advantages of the present disclosure are discussed below in reference to a means for visualization of computer-generated images of paper documents analyzed using OCR/ICR-enabled devices. It has been contemplated that at least portions of the present disclosure may also be utilized for visualizing properties of or editing other types documents or images thereof (e.g., computer graphics, machine-translated documents, and the like).

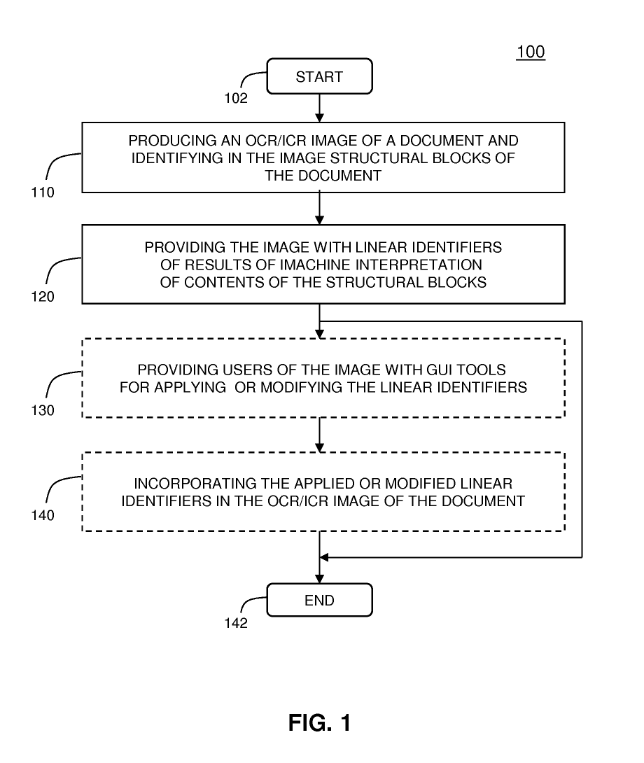

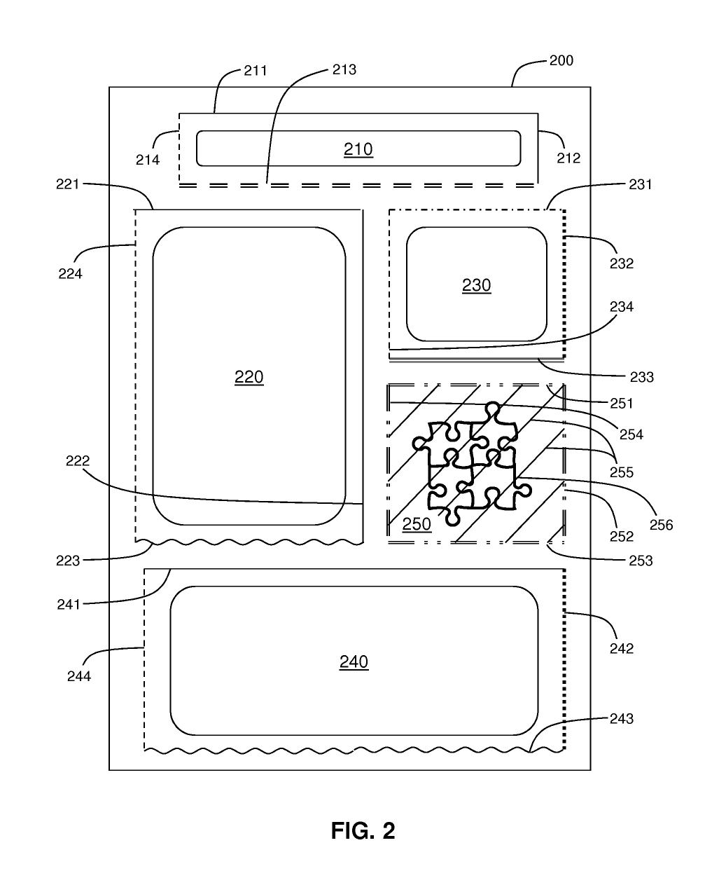

FIG. 1 depicts a diagram illustrating a method 100 of visualizing a computer-generated image of a document according to one embodiment of the present disclosure, and FIG. 2 depicts an exemplary computer-generated image 200 illustrating the method of FIG. 1. For best understanding of the disclosure, it is recommended to refer to FIGS. 1 and 2 simultaneously.

The method 100 starts at step 102 and proceeds to step 110.

At step 110, a computer-generated image of a document (e.g., paper document) is produced. Typically, the image is produced using computerized scanning of the document performed using an OCR/ICR-enable device and includes results of computer-based “machine analysis” of a scan file of the document. Then, in a form of one or several display snapshots or their printout(s), the image is provided to a user(s) for visual examination.

Typically, a computer-performed process of machine analysis of the scan file of the document produces the image wherein contents of the document are presented in a form of individual structural, or logical, blocks. Such a process is disclosed, e.g., in commonly assigned U.S. Pat. No. 8,260,049 B2, issued Sep. 4, 2012.

Portions of the structural blocks may be presented in monochromatic (e.g., black/white, blue/white, etc.) or multi-color formats, as well as provided with other formatting features for separating particular textual and graphical elements of the document. In some embodiments, the image may also include computer-generated notes assisting users (e.g., viewers of the image) in evaluation of accuracy of machine analysis of the document or particular structural blocks thereof.

Referring to FIG. 2, the exemplary computer-generated image 200 of a scanned and machine-interpreted document includes structural blocks 210, 220, 230, 240, and 250. Illustratively, the structural blocks 210, 220, 230 and 240 are predominantly text-containing structural blocks (e.g., title, abstract, table, header, footer, etc.) of the scanned document (for a purpose of clarity, specific text objects of the structural blocks are not shown), while the structural block 250 contains a graphical/pictorial object 256.

At step 120, the computer-generated image of the document (e.g., image 200) is provided with linear identifiers of properties and results of machine analysis (i.e., interpretation of the scan file performed by an OCR/ICR computer program) of contents of the structural blocks of the document. In a displayed/printed image of the document, such identifiers may be applied to the structural blocks or portions thereof in a form of separating lines, border lines, underlines, hatching lines, and the like.

In embodiments, various single or multiple (e.g., including two or more parallel branches) straight or curved lines having sections of same or different widths, as well as lines formed using pre-selected characters (e.g., “#”, “*”, “̂”, etc.), or combinations of these lines may be used as the identifiers. Exemplary single and multiple lines suitable for being used as the identifiers include solid, wavy, dashed, dotted or dash-dotted lines, as well as embattled, indented (“zigzag”), engrailed or break lines, among other lines formed using pre-selected geometrical patterns. A number of such visually recognizable linear identifiers is practically unlimited, thus allowing to provide the users with large amounts of information regarding a status of machine analysis of the scanned document.

Generally, each identifier selectively visualizes a particular characteristic or pre-selected step of a process of machine interpretation of the document, and availability of a large number of visually distinctive identifiers allows to provide viewers of the image with detailed information regarding the results of this process. In embodiments of the method 100, a number, geometrical characteristics, and meanings of employed identifiers may vary, and the users may also be provided with listings (libraries) of the identifiers.

Particular identifiers may indicate a type of content of a structural block (text, table, graphics, picture, etc.), a direction of reading or orientation of text symbols, presence of texts written in specific languages, degree of confidence in interpretation of the content, among other results of machine interpretation of the document. In further embodiments, the users may have a choice of choosing geometric parameters or appearance of the identifiers (e.g., types or widths of lines, etc.) and their configuration or position in the image of the document. In particular, the identifiers may be positioned proximate to one or several sides of a structural block or form enclosing or, alternatively, partially open border lines disposed near peripheral regions of one or several structural blocks. For example, two same or different identifiers may be disposed perpendicular to one another to form an angular border proximate to, e.g., bottom and right sides (or peripheral regions) of a structural block.

In a preferred embodiment, a color of the identifiers (i.e., color of elements of lines forming the respective identifiers) is black. However, in alternate embodiments, all or a portion of the identifiers may be formed using lines of same (i.e., monochromatic lines) or different colors of pre-selected shade or brightness, including multi-colored lines and lines which elements have different colors (e.g., lines having differently colored dashes, dots, etc.). In particular, the identifiers may include lines having portions or specific elements thereof depicted using, for example, black, blue, red, green, yellow, orange and other colors, as well as combinations of such colors.

Referring to FIG. 2, the structural blocks 210, 220, 230, 240, and 250 are provided with arbitrarily chosen linear identifiers discussed above in step 120 of the method 100. Herein, by a way of illustration, a top horizontal single solid line indicates that content of a structural block is text written in user's native language (identifiers 211, 221, 241), a top single dash-dotted line indicates that content of a structural block is text written in a foreign language (identifier 231), a vertical single dotted line indicates that content of a structural block is a table (identifiers 232, 242), a vertical single dashed line indicates a direction of reading text or a table (identifiers 214, 224, 234, 244), an underlining (bottom) single wavy line indicates a completion of interpretation of a content of a structural block (identifiers 223, 243), and an underlining double dashed line indicates that a structural block is a title/subtitle (identifier 213).

Correspondingly, a vertical single solid line indicates that results of machine interpretation of content have been verified/approved (identifiers 212, 222), a bottom horizontal double solid line indicates a request for user's input in interpretation of content of a structural block (identifier 233), a double dash-dotted line indicates that content of a structural block is graphics (identifiers 251-254), and hashed lines (identifier 255) indicate an area occupied by a graphical/pictorial object.

In one embodiment, upon completion of step 120, the method 100 ends at step 142. In an alternate embodiment, upon completion of step 120, the method 100 performs optional steps 130 and 140.

At optional step 130, users of the computer-generated image of the scanned document are provided with graphical user interface (GUI) tools for applying, modifying or replacing the identifiers of the structural blocks in the displayed image of the document. Such editing GUI tools may be provided to users of a computer terminal adapted for providing real-time editing of the displayed image.

At optional step 140, results of user-performed editing of the computer-generated image of the document (i.e., applied, modified or replaced identifiers) are incorporated in the displayed image. In one embodiment, user-edited versions of the image are saved and further used as revised versions thereof.

Upon completion of optional step 140, the method 100 ends at step 142.

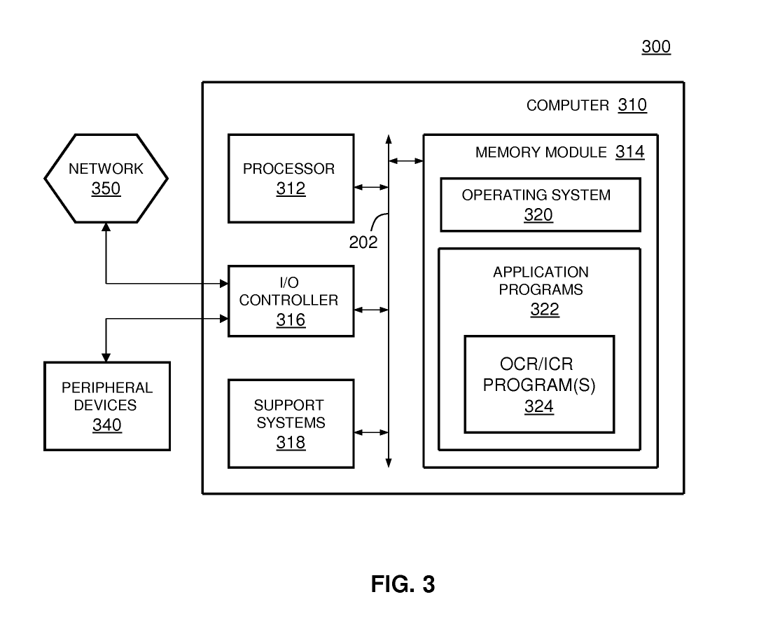

FIG. 3 depicts an exemplary computerized platform 300 utilizing the method 100 of FIG. 1 according to one embodiment of the present disclosure. Those of ordinary skills in the art will appreciate that hardware and software configurations depicted in FIG. 3 may vary.

The platform 300 generally includes a computer 310, peripheral devices 340 (scanners, displays, printers, etc.) and, optionally, is connected to a network 340 (e.g., Intranet, local/wide area network (LAN/WAN), or the Internet). The computer 310 may be implemented as a general purpose or specialized workstation, stationary or mobile computer, or mobile communicating device (e.g., personal digital assistant (PDA), mobile phone, and the like).

The computer 310 generally includes a processor 312, a memory module 314, support systems 318, a system interface 302, and an input/output (I/O) controller 316 providing connectivity to the peripheral devices 340 and network 350. Components of the computer 310 may be implemented as hardware devices, software modules, firmware, or a combination thereof.

In the depicted embodiment, the memory module 314 stores an operating system (OS) 320 (e.g., Microsoft Windows®, GNU®/Linux®, etc.) and application programs (i.e., computer program products) 322. In alternate embodiments, at least portions of the OS 320 and application programs 322 may reside in a remote computing device (e.g., server of the network 350) communicatively coupled to the computer 310.

In the computer 310, the application programs 322 include an OCR/ICR program(s) 324. Among processor-readable instructions provided by the OCR/ICR program(s) 324 are the instructions which, in response to their execution, cause the computer 310 to perform: (i) identifying structural blocks in a computer-generated image of a scanned document, and (ii) providing the image with linear identifiers of properties and states of interpretation of contents of the structural blocks.

Other processor-readable instructions provided by the OCR/ICR program(s) 324 further specify functions and features of such identifiers and a use thereof for visualizing the computer-generated image of the document, as discussed above in reference to the method 100. Optionally or additionally, the processor-readable instructions also provide users of the computer 310 with GUI tools adapted for editing the identifiers employed in the scanned documents.

Aspects of the present disclosure have been described above with respect to visualization of computer-generated images of documents produced using OCR/ICR-based techniques, however, it has been contemplated that portions of this disclosure may, alternatively or additionally, be implemented as separate program products or elements of other program products. All statements reciting principles, aspects, and embodiments of the disclosure and specific examples thereof are also intended to encompass both structural and functional equivalents of the disclosure.

It will be apparent to those skilled in the art that various modifications can be made in the devices, methods, program products of the present disclosure without departing from the spirit or scope of the disclosure. Thus, it is intended that the present disclosure includes modifications that are within the scope thereof and equivalents.

What is claimed is:

1. A method of visualizing a computer-generated image of a document, the method comprising:
identifying in the image structural blocks of the document; and
providing the image with linear identifiers of properties and states of machine interpretation of contents of the structural blocks.

2. The method of claim 1, wherein the image of the document is produced using optical character recognition (OCR) or intelligent character recognition (ICR) techniques.

3. The method of claim 1, wherein the structural blocks comprise text objects, graphical/pictorial objects, or a combination thereof.

4. The method of claim 1, further comprising:
applying the identifiers for selectively separating, underlining or hatching at least portions of the structural blocks.

5. The method of claim 1, further comprising:
using the identifiers including (i) single or multiple solid, dashed, dotted, dash-dotted or wavy lines having sections of same or different widths, or (ii) lines formed using pre-selected characters or pre-selected geometrical patterns.

6. The method of claim 1, further comprising:
disposing the identifiers proximate to peripheral regions of the structural blocks.

7. The method of claim 1, wherein the identifiers include (i) lines of same color or different colors, or (ii) lines having elements of different colors.

8. The method of claim 1, further comprising:
providing users of the image of the document with graphical user interface (GUI) tools for applying, modifying or replacing the identifiers of the structural blocks.

9. The method of claim 9, further comprising:
incorporating the applied, modified or replaced identifiers in the computer-generated image of the document.

10. A platform for visualizing a computer-generated image of a document, the platform comprising:
a local, remote, distributed or web-based computing device; and
a memory locally or remotely coupled to the computing device and storing instructions which, responsive to execution on the computing device, cause the computing device to perform:
identifying in the image structural blocks of the document; and
providing the image with linear identifiers of properties and states of machine interpretation of contents of the structural blocks.

11. The platform of claim 10, further comprising a scanning device adapted for producing at least portions of the image of the document.

12. The platform of claim 10, wherein:
the image of the document is produced using optical character recognition (OCR) or intelligent character recognition (ICR) techniques; and
the structural blocks comprise text objects, graphical/pictorial objects, or a combination thereof.

13. The platform of claim 10, wherein the identifiers are adapted for selectively separating, underlining or hatching at least portions of the structural blocks and comprise (i) single or multiple solid, dashed, dotted, dash-dotted or wavy lines having sections of same or different widths, or (ii) lines formed using pre-selected characters or pre-selected geometrical patterns.

14. The platform of claim 10, wherein:
the identifiers are disposed proximate to peripheral regions of the structural blocks; and
the identifiers include (i) lines of same or different colors, or (ii) lines having elements of different colors.

15. The platform of claim 10, wherein:
users of the image of the document are provided with graphical user interface (GUI) tools for applying, modifying or replacing the identifiers of the structural blocks; and
the applied, modified or replaced identifiers are incorporated in the computer-generated image of the document.

16. A medium storing processor-readable instructions which, responsive to execution in a computing device, cause the computing device to perform:
identifying structural blocks in a computer-generated image of a document; and
providing the image with linear identifiers of properties and states of machine interpretation of contents of the structural blocks.

17. The medium of claim 16, wherein the instructions further cause:
producing the image of the document using optical character recognition (OCR) or intelligent character recognition (ICR) techniques.

18. The medium of claim 16, wherein the instructions further cause:
applying the identifiers for selectively separating, underlining or hatching at least portions of the structural blocks; and
using the identifiers comprising (i) single or multiple solid, dashed, dotted, dash-dotted or wavy lines having sections of same or different widths, or (ii) lines formed using pre-selected characters or pre-selected geometrical patterns.

19. The medium of claim 16, wherein the instructions further cause:
disposing the identifiers proximate to peripheral regions of the structural blocks; and
using the identifiers including (i) lines of same or different colors, or (ii) lines having elements of different colors.

20. The medium of claim 16, wherein the instructions further cause:
providing users of the image of the document with graphical user interface (GUI) tools for applying, modifying or replacing the identifiers of the structural blocks; and
incorporating the applied, modified or replaced identifiers in the computer-generated image of the document.
